(19) United States
(12) Patent Application Publication
(10) Pub. No.: US 2005/0099143 A1
(43) Pub. Date: May 12, 2005

(54) Drive circuit for illumination unit

(76) Inventor: Kazuo Kohno, Sanbu-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/968,041

(22) Filed: Oct. 20, 2004

(30) Foreign Application Priority Data
Nov. 10, 2003 (JP) 2003-379369
Jun. 21, 2004 (JP) 2004-182576
Jul. 6, 2004 (JP) 2004-199070

(51) Int. Cl. H05B 41/16

(52) U.S. Cl. 315/312; 315/276; 315/291; 315/244; 315/318

(57) ABSTRACT

In case of driving a plurality of lamps with the use of a plurality of output transformers, difference in the brightness of each lamp occurs by a dispersion of characteristics of the output transformers, and an object of this invention is to prevent such troubles. For this purpose, primary side of a plurality of output transformers of 1 input.plural output type are respectively connected, and illumination units are connected to the secondary side of each output transformer. All of the secondary output terminals of each output transformer are connected to the secondary output terminals of counter phase are connected by forming a loop circuit with the connection of the output terminals in series in closed loom form and the illumination units are connected between the secondary output terminals of the output transformer and the output terminal of the other output transformer of counter phase with the output terminal.

### BACKGROUND OF THE INVENTION

The present invention relates to a drive circuit used for inverters or the like that drive an illumination unit such as cold cathode fluorescent lamp or EL display (electroluminescence display) and the like.

Heretofore, ballastless type discharge lamp drive circuit using multilamp leakage transformer as a circuit for driving a plurality of discharge lamps has been known (for example, refer to official gazette of Japan Tokkai 2002-075756). Furthermore, a discharge lamp drive circuit has been developed which drives by connecting primary sides of a plurality of output transformers in parallel and connecting the discharge lamps to the secondary sides of each output transformer.

Furthermore, heretofore, in case where an illumination unit such as a plurality of cold cathode fluorescent lamps is driven by using a high tension terminal at secondary side of the wound transformer of one input.2 outputs, as shown in FIG. 17, primary sides of each transformer 1, T2, T3 are connected in parallel, and the illumination units L1-L6 are connected independently to each transformer T1. T2, T3, as shown in the drawing.

In case where the primary sides of a plurality of of output transformers are connected in parallel, and the lamps such as the cold cathode fluorescent lamps are driven for each output transformer, dispersion occurs in characteristics of the output transformer or the load even if they are of the same standard, and dispersion occurs in brightness of the lamps connected to each output transformer owing to the foregoing dispersion.

An object of the present invention is to solve the foregoing problems.

Furthermore, in case of driving a plurality of the lamps, a system of connecting the electrode of the one lamp to the high tension terminal at the secondary side of the output transformer and driving the lamp by connecting the other electrode to the earth is generally employed, but this system has drawbacks such as causing a potential difference at both terminals of the lamp owing to the one terminal side of the lamp being earthed that results in lower voltage of one terminal side of the lamp, and the high tension terminal connection side of the output transformer becomes bright, and the earth side becomes darker, and furthermore, dispersion occurs in luminance between the lamps.

Another object of the present invention is to solve the foregoing problems.

The other object of the present invention is to solve the foregoing problems.

### SUMMARY OF THE INVENTION

The present invention drives a plurality of illumination units by high tension output that is induced at secondary side of each transformer by connecting each primary side of a plurality of output transformers of the same standard of a type that one input against plural outputs to each other, and inputting AC signal to the primary sides. Among the plural illumination units, the electrodes of one side of the plural illumination units where one or mutually connected in series are connected to the high tension terminals at the secondary side of the output transformer of the one part, and the electrode of the other side of the plural illumination units that one piece or mutually serially connected are connected to the other secondary side high tension output terminals of the other part of said pair of output terminals.

Furthermore, the present invention relates to a drive circuit for illumination unit for lighting a plurality of illumination units by high tension output induced at the secondary side of each output transformer by connecting the primary sides of output transformers of one input plural outputs and connecting the illumination units to the secondary sides of each output transformer, and a loop circuit is formed by connecting in a closed loop serially so that all the secondary output terminals of each output transformer are connected to the secondary output terminals of counter phases, and an illumination unit is connected between the secondary output terminal of the output transformer and the output terminal of the other output transformer in counter phase with the output terminal.

When the foregoing construction is formed whereby the dispersion of characteristics of the secondary side of each output transformer can be reduced to a minimum, and the dispersion of brightness of the plural illumination units connected to each output terminal can be reduced to a minimum.

### DESCRIPTION OF DRAWINGS

FIG. 1 denotes a circuit diagram of the illumination unit drive circuit according to the present invention.

FIG. 2 denotes a circuit diagram of the other embodiment of the present invention.

FIG. 3 denotes a circuit diagram of the other embodiment of the present invention.

FIG. 4 denotes a circuit diagram of the other embodiment of the present invention.

FIG. 5 denotes a circuit diagram of the other embodiment of the present invention.

FIG. 6 denotes a plane explanatory drawing of a wound transformer.

FIG. 7 denotes an exterior view of the wound transformer.

FIG. 8 denotes a cross section showing another embodiment of the parallel wound transformer.

FIG. 9 denotes a circuit diagram showing another embodiment of the present invention.

FIG. 10 denotes an explanatory drawing of an output transformer.

FIG. 11 denotes a circuit diagram showing another embodiment of the present invention.

FIG. 12 denotes a circuit diagram showing another embodiment of the present invention.

FIG. 13 denotes a circuit diagram showing another embodiment of the present invention.

FIG. 14 denotes a circuit diagram showing another embodiment of the present invention.

FIG. 15 denotes a circuit diagram showing another embodiment of the present invention.

FIG. 16 denotes a circuit diagram showing another embodiment of the present invention.

FIG. 17 denotes a circuit diagram of conventional technlologies.

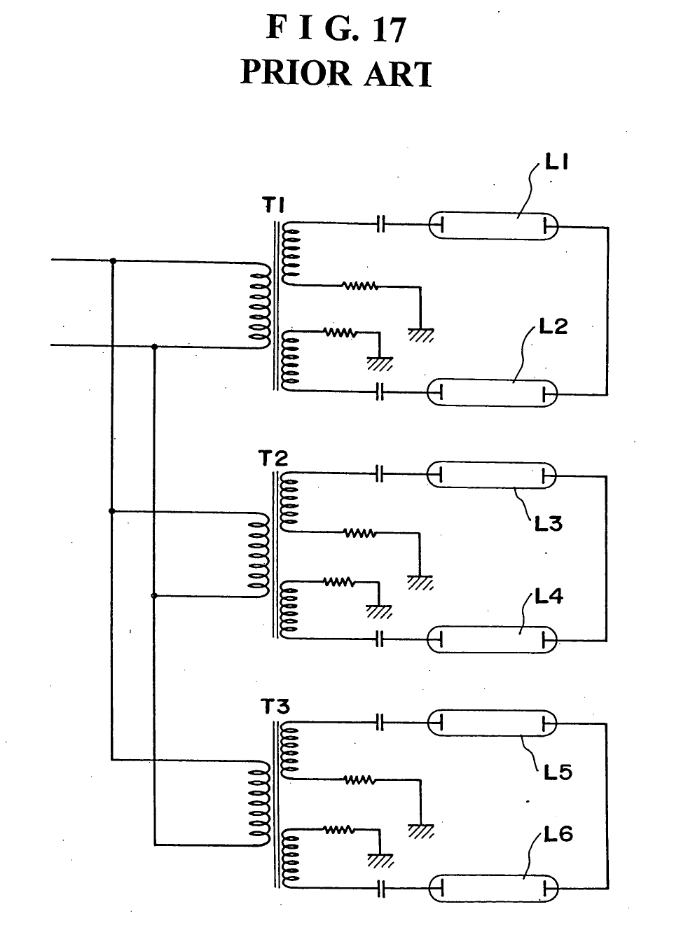

### DETAILED DESCRIPTION OF THE INVENTION

The mode of embodiment of the present invention will be described in the following by referring to attached drawings.

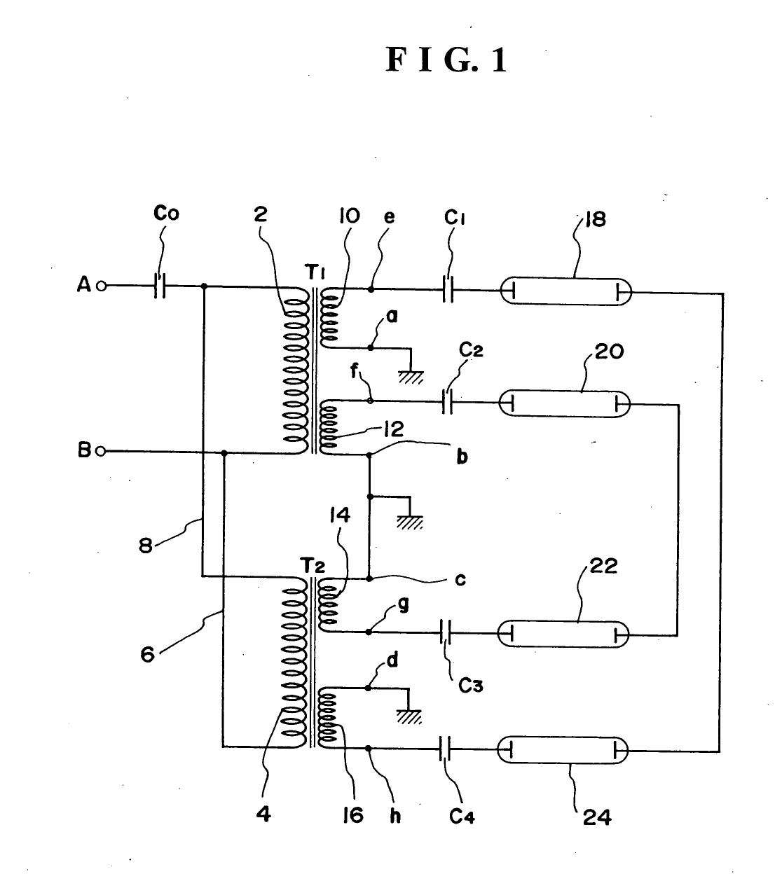

In FIG. 1, T1 and T2 denote output transformer for high tension of identical structure and identical standard wherein one input.2 outputs of wound type are provided, and input windings 2 and 4 at primary side are connected in parallel by lead wires 6 and 8. A series resonance circuit is formed by a resonance capacitor Co and L of a primary winding 2 between input terminals A and B of the output transformer T1. The input terminals A and B are connected to an inverter circuit, and AC voltage to be outputted from the inverter circuit is inputted to the input terminals A and B. Each terminal a, b, c, d of secondary windings 10, 12, 14, 16 of each output transformer T1 and T2 are connected to the earth by means of the terminals.

Reference numerals 18 and 24 denote cold cathode fluorescent lamps, and the lamps are connected serially to each other. An electrode of one terminal of the lamp 18 is connected to a high tension terminal e of the secondary winding 10 of the output transformer T1 by means of the ballast capacitor C1. One electrode of the lamp 24 is connected to a high tension terminal h of the secondary winding of the output transformer T2 by means of the ballast capacitor C4. The terminal e and the terminal h are mutually in counter phase relation. Numeral 20, 22 denote a pair of cold cathode fluorescent lamps connected in series mutually and the electrode of one end of the lamp 20 is connected to a high tension terminal f of the secondary winding 12 of the output trnasformer T1 by means of the ballast capacitor C2. The electrode of one terminal of the lamp 22 is connected to a high tension terminal g of the secondary winding of the output transformer T2 by means of the ballast capacitor C3. The terminal f and the terminal g are mutually in a counter phase relation.

In the foregoing construction, when AC voltage is inputted to the input terminals A and B, and AC voltage of high tension is induced at the secondary side of the output transformers T1 and T2, the high tension AC voltage is impressed at both terminals of each lamp 18, 20, 22 and 24, and the light is on each lamp 18, 20, 22 and 24. There is no occurrence of dispersion of shade since the high tension is impressed at both terminals of each lamp. Furthermore, at this time, even if there is dispersion in characteristics in such as the output transformers T1, T2, lamps, ballast capacitors and the like, the dispersion in characteristics between the output transformers T1 and T2 disappears as the secondary sides of the output transformers T1 and T2 are mutually connected that produce a relevance. On account of the cancellation of the dispersion, 4 pieces of the lamps 18, 20, 22, 24 are operated by standardized characteristics at the secondary side of the output transformers T1 and T2, whereby there is no difference in the brightness between each lamp 18, 20, 22 and 24.

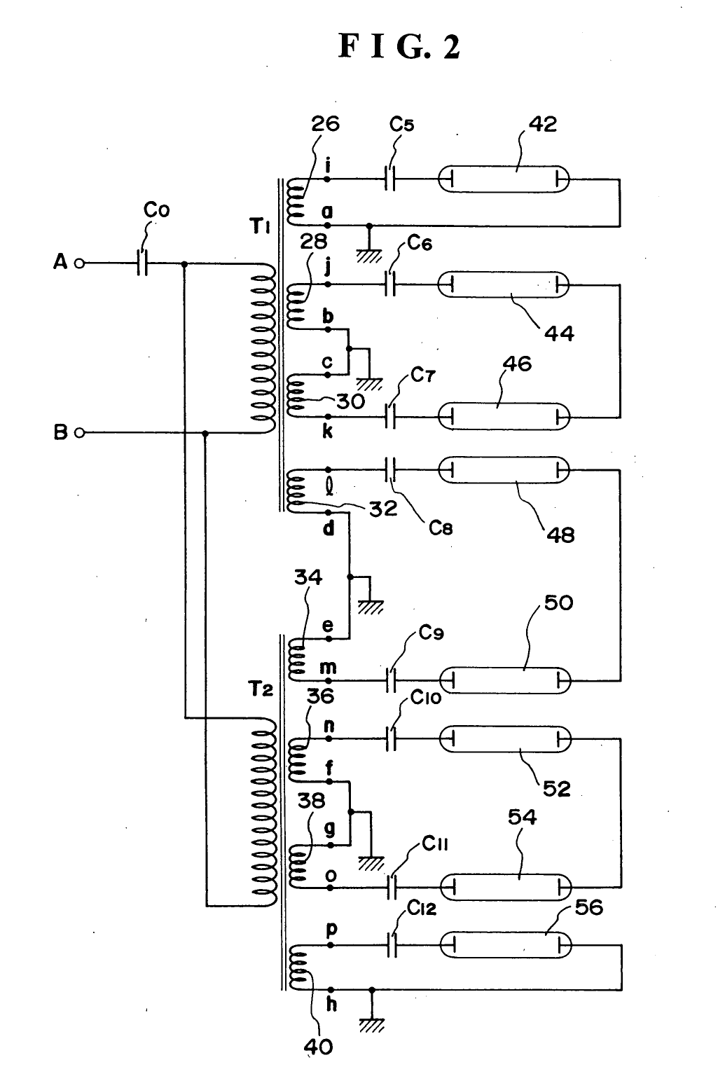

In the foregoing embodiment, an example of using the wound transformer of 1 iuput.2 output as the output transformer with use of cold cathode fluorescent lamp as the load has been explained, however, the embodiments are not particularly limited to these construction and as the output transformer of a plural output types may be used as the output transformer, and as the load, the illumination unit such as the EL display or hot cathode fluorescent lamp and like can be used. Furthermore, the output transformer is not particularly limited to the 1 input.2 output type, and as shown in FIG. 2, wound type 1 input.multiple output transformer may be used. In FIG. 2, T1 and T2 are 1 input.4 output type high tension transformer of wound type of identical structure and identical standard wherein primary sides are mutually connected in parallel, and 8 pieces of the cold cathode fluorescent lamps 42, 44, 46, 48, 50, 52, 54, 56 are connected to the secondary sides thereof as per the drawing.

The lamps 44, 46 are connected in series, and one electrode of one lamp 44 is connected to the high tension terminal j of the secondary winding 28 of the output transformer T1 by means of the ballast capacitor C6, and the other electrode of the other lamp 34 is connected to the high tension terminal k of the secondary winding 30 of the output transformer T1 by means of the ballast capacitor C7. The high tension terminal j and the high tension terminal k are mutually in a counter phase relation. Of the lamps 52 and 54 which are connected in series, the one electrode of the one lamp 52 is connected to the high tension terminal n of the secondary winding 36 of the output transformer T2 by means of the ballast capacitor 10, and the other electrode of the other lamp 54 is connected to the high tension terminal o of the secondary winding 38 of the output transformer T2 by means of the ballast capacitor C11. The high tension terminal m and the high tension terminal o are mutually in a counter phase relation. The low tension terminals f, g of the secondary windings 36, 38 of the output transformer T2 are connected to the earth, and the low tension terminals b, c of the secondary windings 28, 30 of the output transformer T1 are connected to the earth.

The one electrode of the lamp 42 is connected to a high tension terminal i of the secondary winding 26 of the output transformer T1 by means of the ballast capacitor C5, and the other electrode is connected to a ground terminal c of low tension side of the secondary winding 26 of the output transformer T1. The one electrode of the lamp 56 is connected to a high tension terminal p of the secondary winding 40 of the output transformer T2 by means of the ballast capacitor C12, and the other electrode is connected to a low tension terminal h of the secondary winding 40 which is grounded. The one electrode of the lamp 48 among the lamps 48, 50 which are connected in series is connected to a high tension terminal l of the secondary winding 32 of the output transformer T1, and the one electrode of the lamp 50 is connected to a high tension terminal m of the secondary winding 34 of the output transformer T2 by means of the ballast capacitor C9. The high tension terminal l and the high tension terminal m are in mutually counter phase relation. The low tension terminals d, e of the secondary windings 32, 34 of the output transformers T1 and T2 are grounded.

In the foregoing construction, in case the secondary side of the output transformers T1 and T2 are connected by means of the lamps 48, 50, the mutual characteristics are standardized and the dispersions of each characteristics are eliminated. By this arrangement, the lamps 42, 44, 46, 48, 50, 52, 54, 56 that are driven by the secondary side of the output transformers T1 and T2 are lighted on with the brightness of almost the same degree mutually.

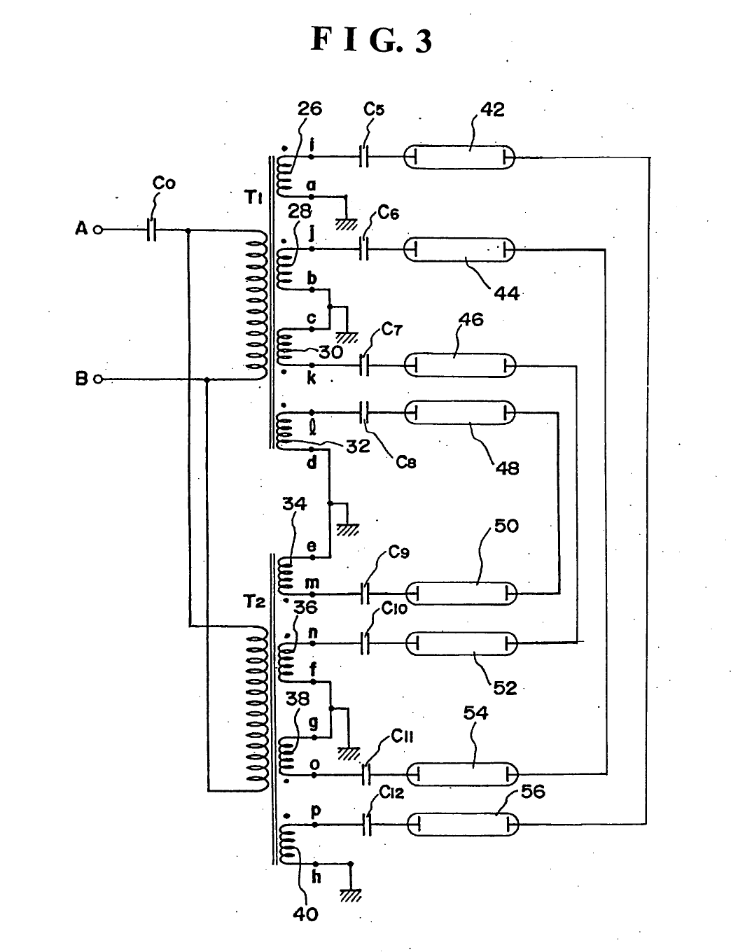

FIG. 3 denotes a modified example of the embodiment illustrated in FIG. 2.

In FIG. 3, T1 and T2 denote 1 input.4 output type high tension output transformers of wound type of identical structure and identical standard, the mutual primary sides being connected in parallel, and 8 pieces of cold cathode fluorescent lamps 42, 44, 46, 48, 50, 52, 54, 56 are connected as shown in the drawing to each secondary side thereof.

The lamps 42, 56 are connected in series, and one electrode of the one lamp 42 is connected to a high tension terminal i of the secondary winding 26 of the output transformer T1 by means of the ballast capacitor C5, and one electrode of the other lamp 56 is connected to a high tension terminal p of the secondary winding 40 of the output transformer T1 by means of the ballast capacitor C12. The high tension terminal i and the high tension terminal p are in mutually counter phase relation. Among the lamps 44 and 52 that are connected in series, one electrode of the one lamp 44 is connected to a high tension terminal j of the secondary winding 28 of the output transformer T1 by means of the ballast capacitor C6, and one electrode of the other lamp 54 is connected to a high tension terminal o of the secondary winding 38 of the output transformer T2 by means of the ballast capacitor C11. The high tension terminal j and the high tension terminal o are in mutually counter phase relation.

One part of the electrodes of the serially connected lamps 46, 52 are connected to a high tension terminal k of the secondary winding 30 of the output transformer T1 by means of the ballast capacitor C7, and the other electrodes are connected to a high tension terminal n of the secondary winding 36 of the output transformer T2 by means of the ballast capacitor C10. One part of the electrodes of the lamps 48, 50 which are connected in series are connected to a high tension terminal l of the secondary winding 32 of the output transformer T2 by means of the ballast capacitor C9, and the other electrode is connected to a high tension terminal m of the secondary winding 34 of the output transformer T2 by means of the ballast capacitor C9. The high tension terminal k and the high tension terminal n, high tension terminals 1 and m are mutually in counter phase relation. The low tension terminals a, b, c, d, e, f, g, h, of the secondary windings 32, 34 of the output transformers T1 and T2 are grounded.

In the foregoing construction, the mutual characteristics are standardized by the connection of the secondary side of the output transformers T1 and T2 by means of the lamps 42, 56, 44, 54, 46, 52, 50, and the dispersion of each characteristic is eliminated. With this construction, the lamps 42, 44, 46, 48, 50, 52, 54, 56 which are driven by the secondary side of the output transformers T1 and T2 are lighted up mutually with almost the same brightness.

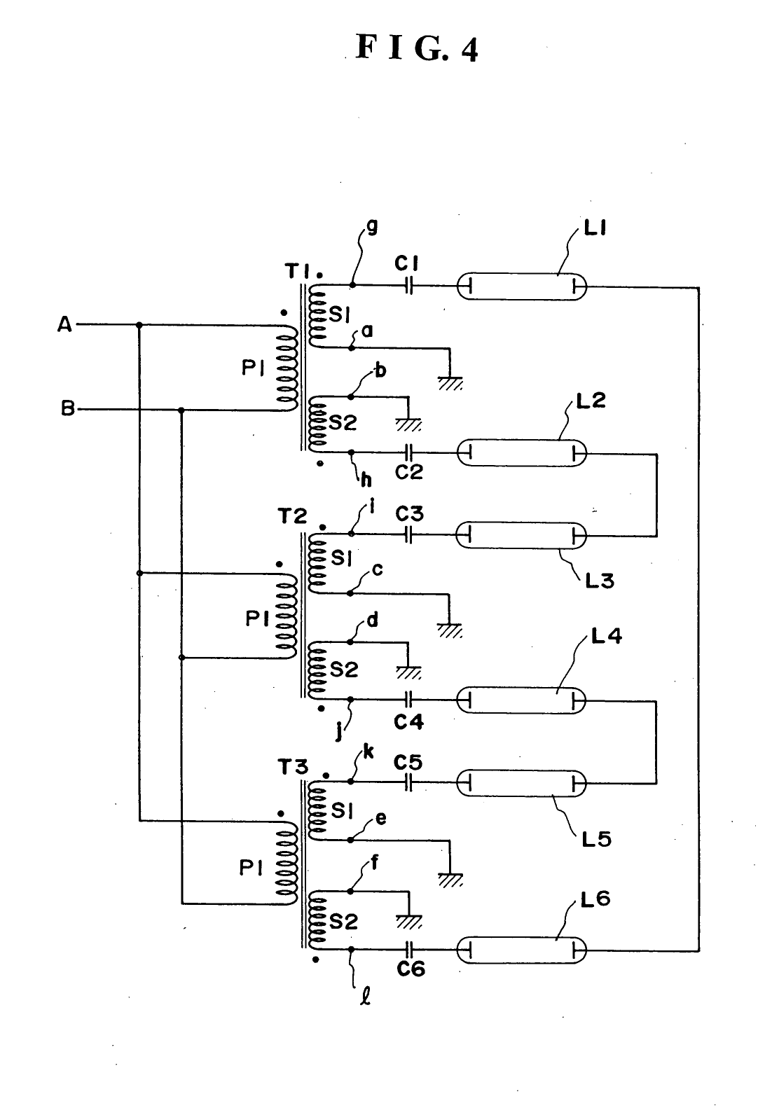

Another embodiment of the present invention will be explained in the following by referring to FIG. 4. In FIG. 4, T1, T2 and T3 denote output transformers for high tension of 1 input.2 output type of identical structure and identical standard, and an input winding P1 at the primary side of each transformer are connected in parallel by lead wires. The input terminals A and B of output transformer T1 are connected to, for example, parallel resonance inverter circuit of the leuyer system, series resonance inverter circuit, separately excited inverter circuit that supply AC signals to the primary side of the output transformer T1. The low tension side terminals a, b, c, d, e, f, for connection to each winding terminal of the secondary windings S1, S2 of each output transformer T1, T2, T3 are connected to the earth.

L1, L6 denote cold cathode fluorescent lamps, and the lamps are mutually connected in series. One electrode of the cold cathode fluorescent lamp L1 is connected to a high tension side terminal g for connection to a winding start end of the secondary winding S1 of the output transformer T1 by means of the ballast capacitor C1, and one electrode of the cold cathode lamp L6 is connected to low tension side terminal l connected to winding start end of secondary winding S2 of the output transformer T3 by means of the ballast capacitor C6. electrode of lamp L2 among a pair of lamps L2, L3 which are connected mutually in series is connected to a high tension side terminal h for connection to the winding start end of the secondary winding S2 of the output transformer T1 by means of ballast capacitor C2, and the one electrode of the other lamp L3 is connected to high tension side terminal i connected to start winding end of secondary winding S1 of output transformer T2 by means of the ballast capacitor C3. The electrode of the lamp L4 among the lamps L4, L5 of mutual serial connection is connected to high tension side terminal j for connection to winding start end of the secondary winding S2 of output transformer T2 by means of ballast capacitor C4, and the electrode of the lamp L5 is connected to high tension side terminal k connected to winding start end of secondary winding S1 of output transformer T3 by means of ballast capacitor C5. High tension side terminals g and h and i and j and k and l of each output transformer T1, T2, T3 are mutually in the counter phase relation, and connecting points of the lamps L1 and L6 and L2 and L3, L4 and L5 become apparently zero volts.

In the foregoing construction, when AC signal is inputted to the primary side of the output transformers T1, T2, T3 from the input terminals A and B, and AC voltage of high tension is induced at the secondary side of the output transformers T1, T2 and T3, the high tension AC voltage is impressed to both terminals of each lamp L1, L6, L2, L3, L4, L5. At both terminals of the secondary windings S1 and S2 of each output transformer T1, T2, T3, voltage corresponding to an impedance of total including load connected to both windings generates. At this time, for example, at the secondary winding S2 of the output transformer T1 and the secondary winding S1 of the output transformer T2, the related voltage generates by means of the lamps L2,L3 connected in series. Similarly, at both the terminals of the secondary winding S1 of the output transformer T1 and the secondary winding S2 of the output transformer T3, the related voltage generates by means of the lamps L1 and L6 connected in series. Furthermore, at both terminals of the secondary winding S2 of the output transformer T2 and the secondary winding S1 of the output transformer T3, the related voltage generates by means of the lamps L4 and L5. By this arrangement, all of the output transformers T1, T2 and T3 are caused to co-relate to flow a uniform electric current through all the lamps L1-L6 to keep the uniform brightness. This means that the related voltage generates in the secondary windings S1 and S2 of each output transformer T1, T2, T3 even if there is dispersion in the load impedance of the output transformers T1, T2 and T3. Furthermore, at this time, when the potential difference occurs in the secondary windings S1 and S2, an operation of shunt trans in the windings of S1 and S2 which causes the electric current energizing in the S1 and S2 to be the same current, and electric current correction of S1 and S2 is taken place. By the foregoing operation, all the lamps L1-L6 light up with the same brightness. Furthermore, even if the constant of the impedance parts of the lamps changes due to temperature change, the stable brightness can be provided for each of the lamps L1-L6 by the foregoing operation.

As described in the foregoing, the voltage at both terminals of the secondary windings S1 and S2 of each output transformer becomes uniform whereby the voltage of the winding P1 of the primary side of each output transformer T1, T2 and T3 becomes almost the same value, and thus, the stabilized lamp driving becomes possible. At the primary side of each of the output transformer, the voltage corresponding to the winding ratio of the primary and secondary windings generates. Namely, the voltage of a fraction of winding number of the voltage generated in the secondary winding generates, and this means that if the voltages at the secondary side of the output transformers T1, T2 and T3 are respectively equal, the voltage at the primary side of each of the output transformers becomes equal, and the supplied electric power becomes the same. For reference, in the mode of this embodiment, the lamps are not limited particularly to the cold cathode fluorescent lamp, and also, the output transformers are not particularly limited to the wound type, and can be used for piezoelectric transformers and the like.

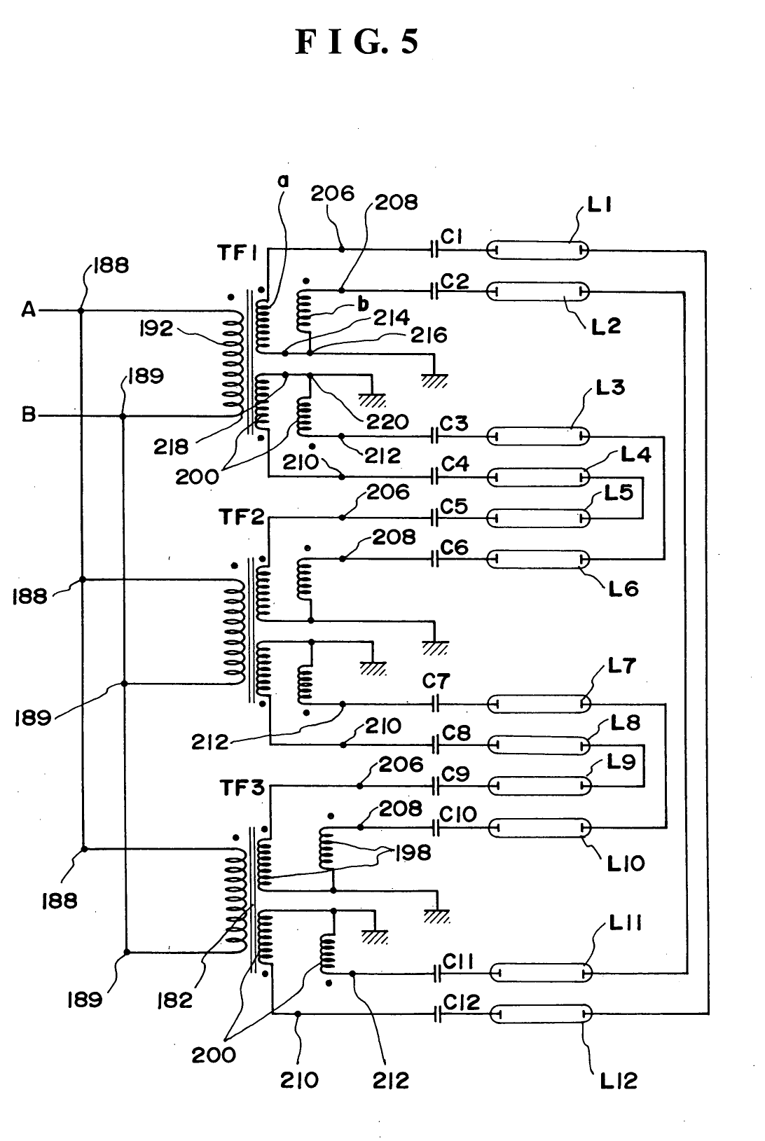

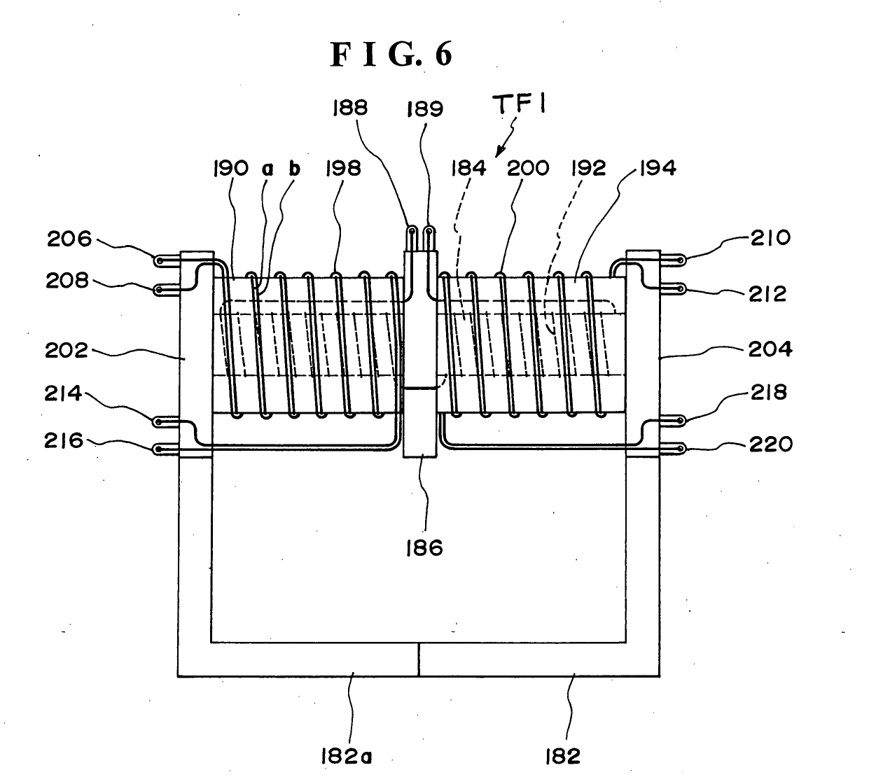

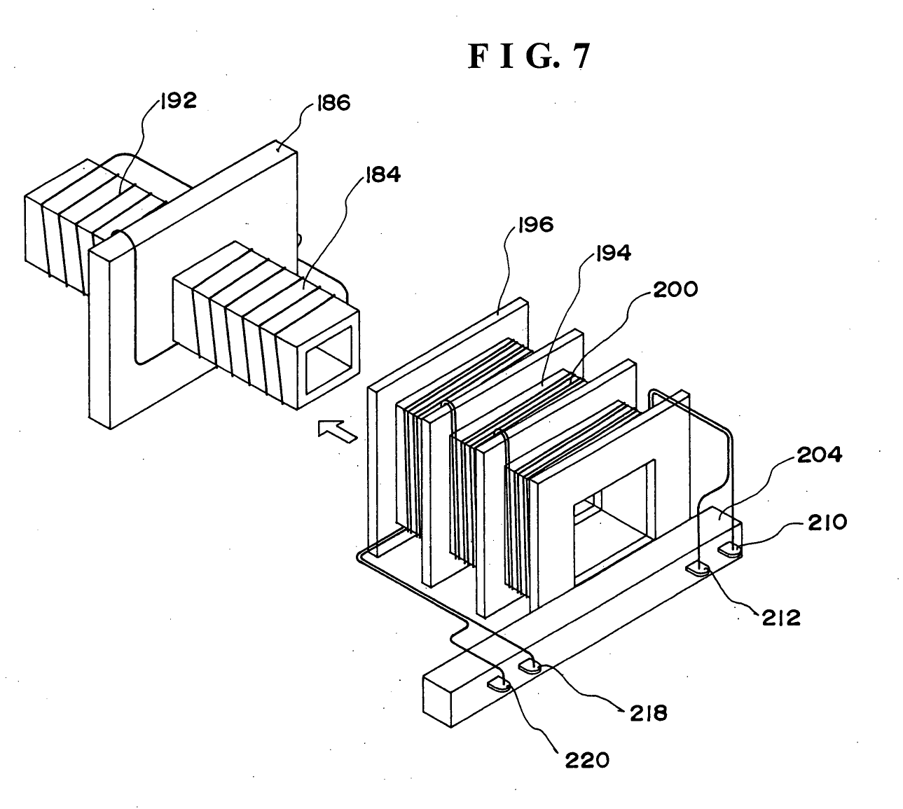

FIG. 5 shows an embodiment wherein secondary side is put to a bifilar winding (parallel winding), and 3 pieces of a plurality of transformers TF1, TF2 and TP3 with 1 input.4 output type are used, and 12 pieces of lamps L1-L12 are operated. FIGS. 6 and 7 show the transformer TF1 of 1 input 4 outputs of bifilar winding.

In FIG. 6, numeral 182 denotes a core, and a core is of ] shape formed by joining two pieces of □-shape core. On the part of parallel portion of the core 182, a bobbin 184 for primary is inserted and disposed. In the center of the bobbin 184 for primary, a terminal base 186 is fixed, and primary input terminals 188 and 190 are provided on the terminal base. On the bobbin 184, a primary winding 192 is wound, and both terminals of the primary winding 192 are connected to the primary input terminals 188 and 190 by means of lead wire.

To the outside of the bobbin 184 for primary, a pair of bobbins 191 and 194 for secondary are inserted and disposed by being positioned at both sides of the terminal base 186. A partition 196 at one end of the bobbins 191, 194 for secondary abuts on both sides of the terminal base 186. In FIG. 6, the partition 196 of the secondary bobbins 191, 194 is omitted from the drawing in order to avoid complication of the drawing. On the bobbins 191, 194 for secondary, secondary windings 198, 200 are wound with two pieces of wires a, b which are superposed. The winding start of the secondary windings 198, 200 made of double wires is connected to secondary high tension terminals 106, 208, 210, 212 provided on each terminal base 202, 204 of the secondary bobbins 191, 194, and the winding finish end is connected to ground terminals 214, 216, 218, 220 by means of lead wires.

In the foregoing construction, the relationship of the primary winding 192 and the secondary windings 198 and 200 is such that in the double layer structure of the bobbins, the secondary winding 198 and 200 are disposed at both sides of the primary winding, which products multiple outputs by a simple structure. In this embodiment, high tension may be exerted on the double parallel wires forming the secondary winding but this high tension is of mutually identical electric potentials so that there is no chance of causing shorting or leakage of electric current in the parallel secondary windings. Furthermore, the other parallel portion 182a of the core 182 can be constituted similarly, and in case of making it like a vertical symmetrical structure, the primary side is made as one input by connecting them in series or parallel, and thus, 8 outputs can be materialized. Furthermore, multiple outputs can be arranged by making the numbers of windings of the secondary windings to be three pieces or four pieces. In FIG. 5, TF1, TF2, TF3 show that input terminals 188, 189 at the primary side are connected in parallel by the lead wires. The input terminals 188, 189 of the output transformer TF1 are connected to, for example, parallel resonance inverter circuit of luwyer type, series resonance inverter circuit, separate excitation type inverter circuit are connected which supplies AC signals to primary side of the output transformer TF1. Low tension side terminals 214, 216, 218, 220 which are connected to each winding end of the secondary windings 198, 200 of each output transformer TF1, TF2, TF3 are connected to the earth. L1 and L2, L2 and L11 are cold cathode fluorescent lamps, and the lamps are connected mutually in series. One part of electrodes of the cold cathode fluorescent lamps L1, L2 are connected to high tension side terminals 206, 208 connected to the winding start end of the secondary winding of the output transformer TF1 by means of the ballast capacitors C1, C2, and one part of electrodes of the cold cathode fluorescent lamps L12, L11 are connected to high tension side terminals 210, 212 connected to the winding start end of the secondary winding of the output transformer TF3 by means of the ballast capacitors C12, C11. Among a pair of lamps L3, L6 and a pair of lamps L4, L5 which are mutually and serially connected, one part of electrodes of one part of the lamps L3, L4 are connected to the high tension side terminals 212, 210 connected to the winding start end of the secondary winding 200 of the output transformer FT1 by means of the ballast capacitors C3, C4, and one part of electrodes of the other part of the lamps L5 and L6 are connected to the high tension side terminals 206, 208 connected to the winding start end of the secondary winding of the output transformer TF2 by means of the ballast capacitors C5, C6.

Among a pair of lamps L7, L10 and a pair of lamps L8, L9 which are mutually and serially connected, one part of electrodes of one part of the lamps L7, L8 are connected to the high tension side terminals 212, 210 connected to the high tension side terminals 212, 210 by means of the ballast capacitors C7, C8, and one part of the electrodes of the other lamps L9, L10 are connected to high tension side terminals 206, 208 connected to the winding start end of the secondary winding of the output transformer TF3 by means of the ballast capacitors C9, C10. The high tension side terminals 206, 208 of each of the output transformers TF1, TF2, TF3 and the high tension side terminals 210, 212 are in counter phase relation with respect to each other, and connecting points of the lamps L1 and L2, L2 and L11, and L3 and L6, and L4 and L5, and L7 and L10, L8 and L9 become apparently zero volts. For reference, in this embodiment, the lamps are not limited particularly to the anode cathode lamps and also are not limited to the output transformers or to the wound type, and the piezoelectric transformers and the like may be used.

In the foregoing construction, when the AC signals are inputted to the the primary side of the output transformers TF1, TF2, TF3 from the input terminals A and B of the circuit, and the AC voltage of high tension is induced at the secondary side of the output transformers TF1, TF2, TF3, the high tension AC voltage is impressed to each terminal of each lamp L1, L12, L2, L11, L3, L6, L4, L5, L7, L10, L8, and L9. The voltage corresponding to the impedance of the total including the load connected to both terminals of the windings generates at both terminals of the secondary windings 198, 200 of each output transformer TF1, TF2, TF3. At this time, the related voltage generates by means of the lamps L2, L5 and L4 and L5 which are connected in series generates, for example, at the secondary winding 200 of the output transformer TF1 and the secondary winding 198 of the output transformer TF2. Similarly, the related voltage by means of the serially connected lamps L1, L2 and L11, L12 generates at both terminals of the secondary winding 198 of the output transformer TF1 and the secondary winding 200 of the output transformer TF3. Also, the related voltage by means of the lamps L7, L10, L8, L9 generate at both terminals of the secondary winding 200 of the output transformer TF2 and of the secondary winding 198 of the output transformer TF3.

By this arrangement, all of the output transformers TF1, TF2, TF3 come to be related, and the uniform electric current flows in all of the lamps L1-L12, and the brightness becomes uniform. This arrangement means that even if there is the dispersion, the related voltage generates at the secondary windings 198 and 200 of each output transformer TF1, TF2, TF3. Furthermore, when the voltage difference occurs in the secondary windings 198 and 200, the operation of the shunt transformer occurs in the secondary winding 198 and 200, and the electric current flowing in the secondary windings 198 and 200 tend to be the same which causes the electric current correction of the secondary windings 198 and 200. The electric current correction is taken place by the operation of the shunt transformer similarly between the windings a and b of the secondary winding 198, and the electric current correction is taken place by the operation of the shunt transformer similarly between the windings a and b of the secondary winding 200.

With the foregoing operation, all of the lamps L1-L12 are lighted up with the same brightness. Furthermore, the stable brightness can be obtained for each lamp L1-L12 by the foregoing operation even if the constant of the impedance of the lamps change by the change of temperatures. As described in the foregoing, when the voltages at both terminals of the secondary windings 198, 200 of each of the output transformers TF1, TF2, TF3 become uniform, whereby the voltages of the winding 192 at the primary sides of each of the output transformers TF1, TF2, F3 become the same value, and the stable operation of the lamps can be feasible. At the primary side of each output transformer, the voltage corresponding to a ratio of windings of the primary and secondary windings generates. Namely, the voltage generates which is a fraction of the number of windings of voltage generated at the secondary winding, and this means that if respective voltages at the secondary sides of the output transformers TF1, TF2, TF3 are almost equal, the voltages at the primary side of each output transformer becomes equal, and the supplied electric power becomes equal.

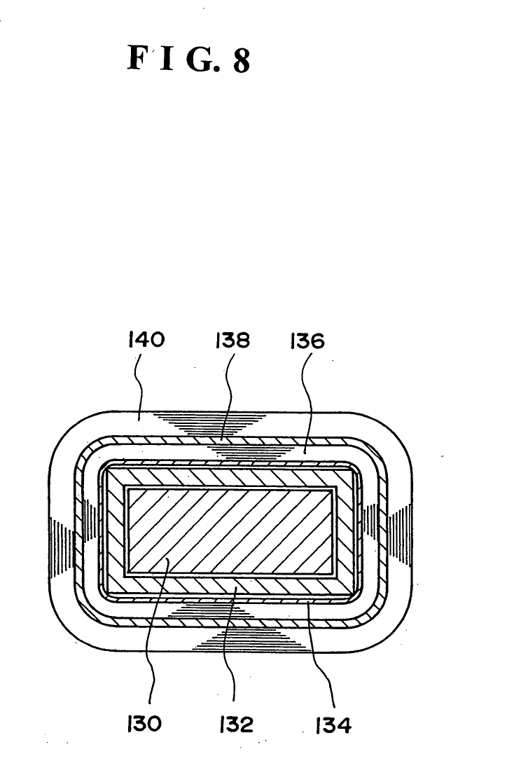

FIG. 8 shows another embodiment of the parallel winding of the wire in the transformer. the first primary winding 136 is laminated on a bobbin 132 build in with a core 130 by means of an insulator 134 and the winding is wound, and the secondary winding 140 is laminated with the same number of winding with the first secondary winding 136 on the first secondary winding 136 by means of an insulator 138 and the winding is wound, and the first and the second secondary windings 136 and 140 corresponding to two pieces of the windings a and b of FIG. 5 may be formed in a lamination structure. For reference, the first secondary winding 136 may be formed in a bifilar winding consisting of more than two pieces of wires, and similarly, the second secondary winding 140 may be formed in bifilar winding consisting of more than two pieces of wires. In FIG. 8, 1 input.4 output wound type transformer may be produced by producing the secondary windings 136, 140 of the first and second with two pieces of wires respectively. The transformer of this lamination structure may be used in all of the embodiments of the present invention.

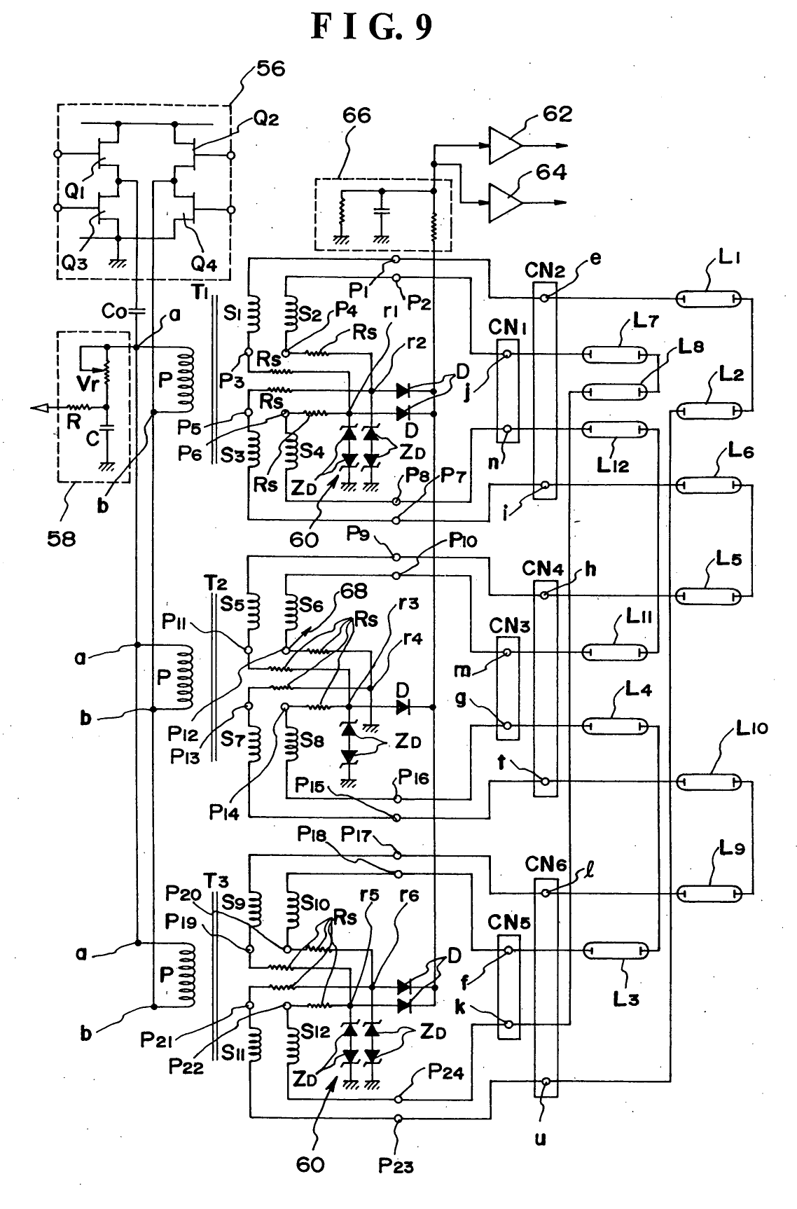

Another embodiment of the present invention will be described in the following by referring to FIG. 9. In FIG. 9, the output transformers T1, T2, T3 show the 1 input.4 output type wound transformer with secondary winding formed by winding with bifilar wound with the identical standard and identical core mutually, and the input terminals a, b at each primary side are connected in parallel with the lead wires. For reference, the foregoing output transformers T1, T2, T3 are limited particularly to the wound type transformer whose secondary windings are wound on the identical cores by the bifilar winding, and they may be wound on the different cores or any structure of transformers may be used as long as they are of the 1 input plural output type transformers such as the piezoelectric transformers. The input terminals a, b of the output transformer T1 are connected to the output unit of a self-oscillation circuit 56 of bridge type consisting of 4 pieces of FETQ1. Q2. Q3, Q4 by means of the resonance capacitor Co. The resonance capacitor Co and the primary winding of the output transformer T1 are connected in series and an LC series resonance circuit is formed at the primary side of the output transformer T1.

A phase detecting circuit 58 is connected to an input terminal a positioned at a middle point of the LC series resonance circuit at the primary side of the output transformer, and a phase signal at the primary side of the output transformer T1 is supplied to the control unit (drawing is omitted) of the self-oscillation circuit 56 through the lead wires. For reference, a power source circuit for supplying an AC signal to the primary side of the output transformer T1 is not limited particularly to the self-oscillation circuit 56 of full bridge type, and parallel resonance inverter circuit of layer system, separately excited nverter circuit and the like can be used. Each output terminal of all coils S1-S12, a total of 12 pieces, at the secondary side of the output transformers T1, T2, T3 is connected mutually in series on a loop circuit forming a closed circuit. This loop circuit is constructed by a closed loop current path, based on one output terminal p1 of the coil S1 as a basis, and starting from this output terminal p1 and returning to another output terminal p3 of the coil S1.

The route of this loop circuit is formed by a closed loop starting with an output terminal p1, terminal e of terminal table CN2, lamp L1 (CCFL), lamp L2, coil S11, resistor Rs, resistor Rs, coil S10, terminal f of terminal table CN5, lamps L3, L4, terminal g of terminal table CN3, coil S8, resistor Rs, resistor Rs, coil S5, terminal i of terminal table CN2, coil S3, resistor Rs, resistor Rs, coil S2, terminal j of terminal table CN1, lamp L7, L8, terminal k of terminal table CN5, coil S12, resistor Rs, coil S9, terminal l of terminal table CN6, lamps L9, L10, coil S7, resistor Rs, resistor Rs, coil S6, terminal m of terminal table CN3, lamps L11, L12, terminal n of terminal table CN1, coil S4, resistor Rs, resistor Rs in this order, and is led to another output terminal P3 of the coil S1. Connecting points r1, r2, r3, r5, r6 of the coils of each output transformer T1, T2, T3 are connected to a voltage clamp circuit 60 formed by Zener diode ZD, Zd or surge absorber and the like respectively.

The connecting point r4 of the output transformer T2 is connected to the ground for receiving a lamp current detecting signal from a shunt resistor Rs to the lead wire 68. The connecting points r1, r2, r3, r5, r6 of each coil of each of the output transformer T1, T2, T3 are connected to each input terminal of a lamp open detecting comparator 62 and a lamp deterioration detecting comparator 64 by means of diode D and voltage detecting circuit 66. Output terminals p1, p2, p9, p10, p17, p18 of the output transformers T1, T2, T3 are of identical phase, and output terminal p7, p8, p15, p16, p23, p24 are in counter phase relative to the output terminals. Furthermore, output terminals p3, p4, p11, p12, p19, p20 are mutually identical phase, and the output terminals p5, p6, p13, p14, p21, p22 are in counter phase to the output terminals. With this relationship, each connecting points of a pair of lamps and each connecting point r1-r6 of the coils which are mutually connected in series become apparent zero volts. The output terminals of the comparators 62, 64 are connected to the control unit of the self excitation oscillation circuit 56 thereof.

In the foregoing construction, when the AC signal is inputted to the primary side P of the output transformers T1, T2, T3 from the output unit of the self-oscillation circuit 56, and high tension is induced at the secondary side of the output transformers T1, T2, T3, identical current flows to each lamp L1-L12 through the loop circuit connecting the coils of each output transformer T1, T2, T3, and lights up each lamp L1-L12 with identical luminance. When disconnection occurs in any of lamps or wiring on the loop circuit or in the wiring of the output transformers, high tension of several minutes of output of the output transformers T1, T2, T3 occurs in the loop circuit. When the high tension occurs, the voltage balance of the loop circuit is ill balanced, and the voltage exceeding the set Zener voltage generates. At this time, the loop circuit is connected to the ground through a voltage clamp circuit 60, and the loop circuit is clamped to a predetermined voltage. Thus, this arrangement prevents the generation of abnormal voltage in the loop circuit. On the other hand, when the abnormal voltage occurs in the connecting points r1-r6, this voltage signal is detected by a voltage detecting circuit 66 through a diode D, and this detecting signal is inputted to the comparators 62, 64. The comparator 62 outputs a lamp open detecting signal, and stops the driving of the self-oscillation circuit 56. Furthermore, when the lamps L1-L12 deteriorates, and the loop circuit is ill balanced, unbalanced current flows into the voltage clamp circuit 60 as a reactive power, and thus, the lamp deterioration signal is produced. This lamp deterioration signal is supplied to the comparator 64, and this comparator 64 outputs the lamp deterioration signal, and stops the self-oscillation circuit 56. For reference, in this embodiment, the primary side P of the output transformers T1, T2, T3 are respectively connected in parallel to the output unit of the self-oscillation circuit 56, but, it is not particularly limited to this connecting system, and may be serial connection.

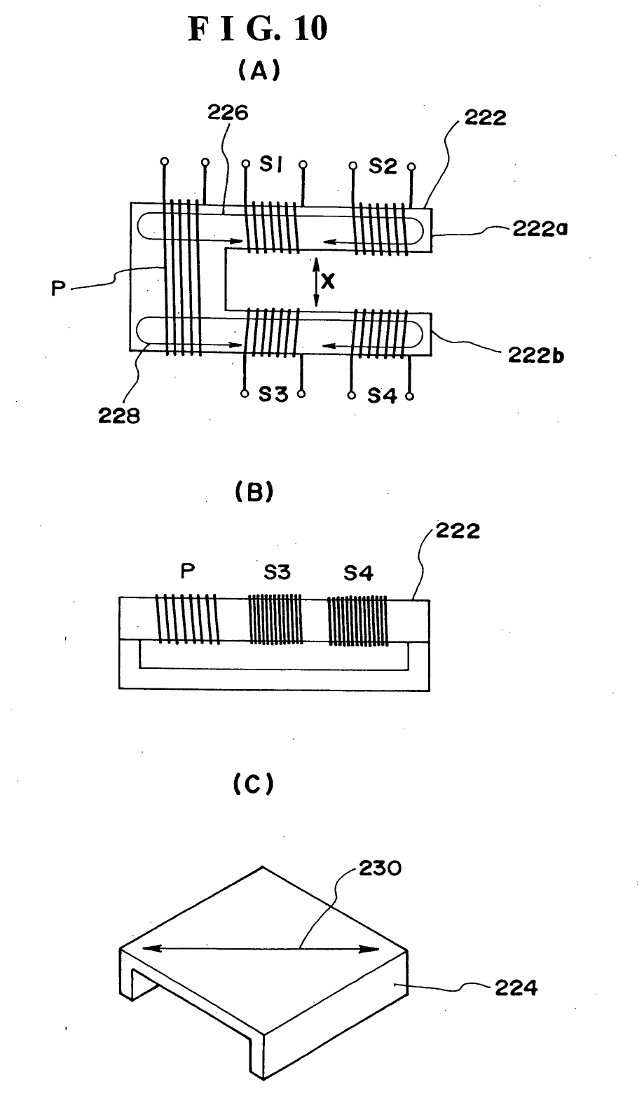

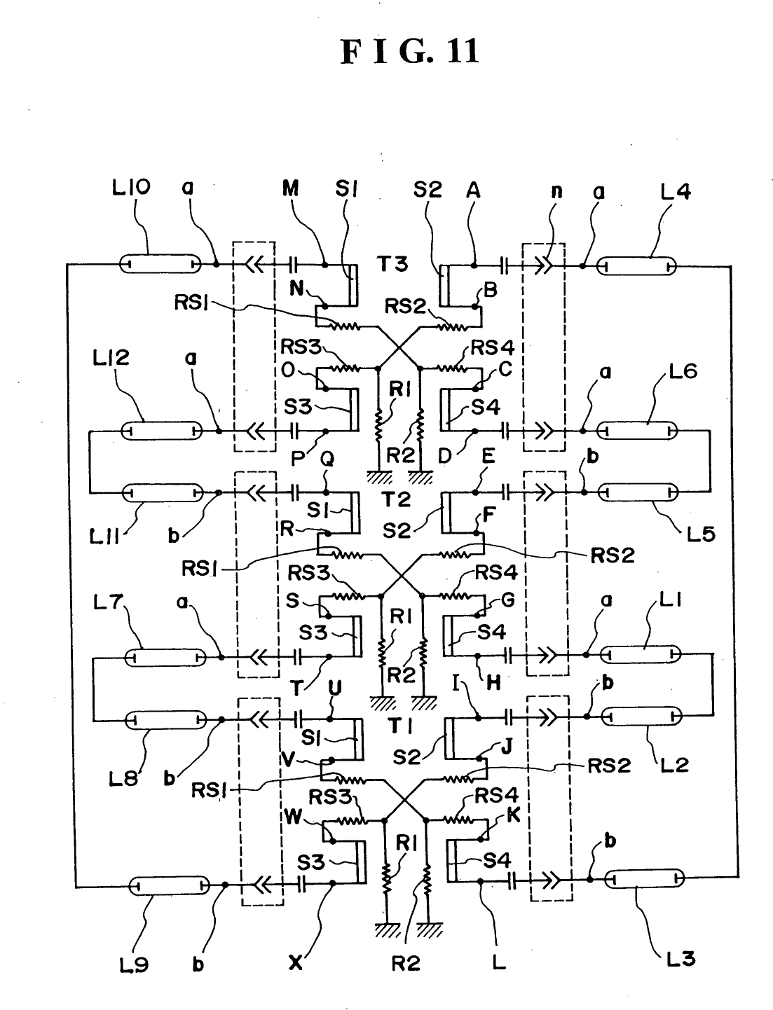

FIG. 11 shows a modified example of the construction wherein a plurality of lamps are connected in loop form. The output transformers T1, T2, T3 are provided with an upper core 222 and a lower core 224 of U-shape as shown in FIG. 10, and the upper core 222 is provided with a primary coil P and 4 pieces of secondary coils S1, S2, S3, and S4. The secondary oils S1, S2 and S3, S4 may be formed in a parallel winding as shown in FIG. 6 respectively. In FIG. 11, the primary side of the output transformers T1, T2, T3 are identical with the construction shown in FIG. 9, and this portion is omitted. A pair of lamps L1, L2, lamps L3, L4, lamps L5, L6, lamps L7, L8, lamps L9, L10, lamps 11, 12 are respectively connected to the high tension output terminals at the secondary side of the output transformers T1, T2, T3 as shown in the drawing. The high tension terminals at the secondary side of the output transformers connected to the one side a and the other side b of each pair of lamps are in counter phase mutually. Namely, the output terminals A and L are mutually in counter phase, and similarly, D and E, H and I, M and X, P and Q, and T and U are mutually in counter phase.

The terminals N and C, R and G, V and K which are mutually in counter phase at the one side of the secondary coils S1 and S4 of each output transformer T1, T2, T3 are connected by means of the resistors RS1, RS4 as shown in FIG. 11. The terminals B and 0, F and S. J and W are connected by means of the resistors RS2, RS3 which are in counter phase relation by means of the resistors RS2, RS3. Each output terminal of all the secondary coils S1, S2, S3 S4 in total of 12 pieces is connected in series mutually on one pieces of a loop circuit forming the closed loop. This loop circuit is formed by one piece of the closed loop circuit electric current carrying route that starts from this terminal H based on the terminal H of one side of the secondary coil S4 of the output transformer T2, through the coils S1, S4 of the output transformer T3, coils S2, S3 of the output transformer T2, coils S1, S4 of the output transformer T2, coils S1, S4 of the output transformer T1, coils S2, S3 of the output transformer T3, and lamps 12, 11, and c oils S1, S4 of the output transformer T2, and come back to this terminal H. For reference, N in the drawing denotes a connector.

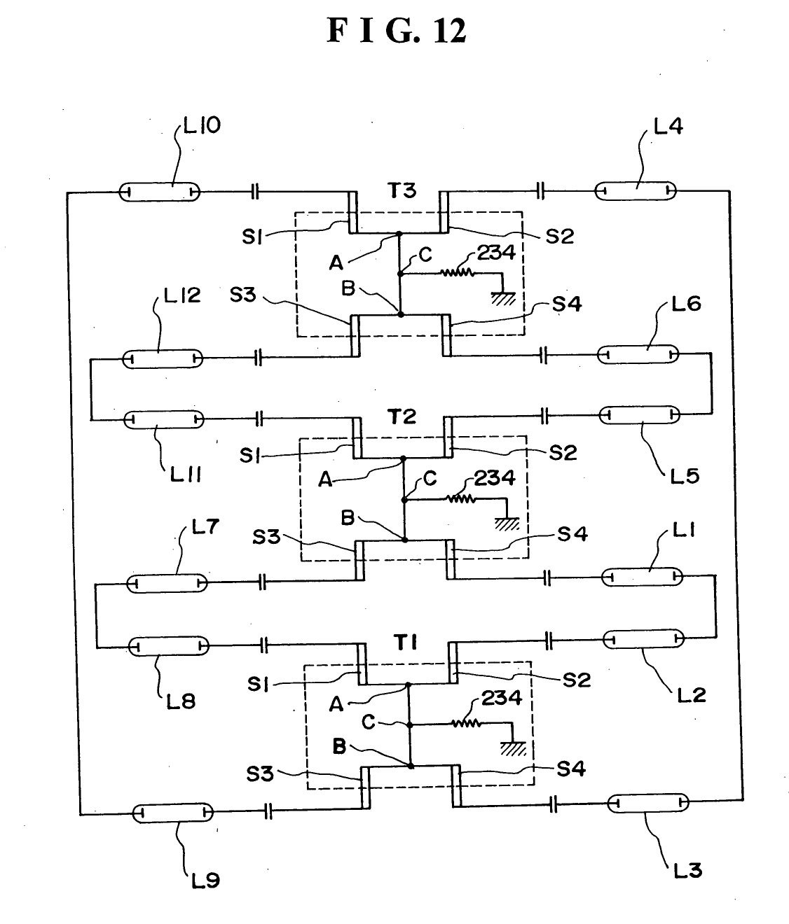

Next, an improved embodiment of the embodiment shown in FIG. 1 is explained by referring to FIG. 12. The output transformer used in the lamp drive circuit generates normally magnetic line of forces 226, 228, as shown in FIG. 10A, on one core portion 222a of the upper core 222 and the other core portion 222b. When an unbalance occurs in the electric current of the secondary coils S1, 62 of the core portion 222a and the secondary coils S3, S4 of the core portion 222b, a coupling capacitor X generates between the core portion 222a and the core portions 222b and the magnetic line of force 230 generates on the lower core portion 224. The electric current flows between the core portions 222a and 222b by the magnetic line of force 230 and the electric current totally becomes invalid electric current, causing an unbalance in the electric current flowing in the secondary coils S1 and S2 of the core portion 222a and the secondary coils S3 and S4 of the core portion 222b. The present invention dissolves this phenomenon by connecting (short-circuiting) the terminals NB, OC, RF, SG, VJ, WK at one side of the identical phase of the secondary coils S1 and S2 of each output transformer T1, T2, T3 as shown in FIG. 12, and the series connection (short-circuiting) of each middle point AB of the short-circuiting line is effected by the line 232, and the mid point of the line 232 is connected to the ground through a high resistor 234 of 1 ohm.

As described in the foregoing, when a point A and a point B are connected in series with a line 232, the electric current flows between the A and B, and the coils S1, S2 of the secondary coils and the secondary coils S3, S4 of each output transformer T1, T2, T3 becomes an equal voltage (potential). Each output terminal of all the secondary coils S1-S4 of total of 12 pieces at the secondary side of the output transformers T1, T2, T3 is connected in series mutually on one piece of the loop circuit forming the closed loop. 12 pieces of the lamps L1-L12 are connected in series to the loop circuit, and the electric current flows to the 12 pieces of the lamps through the line 232 connecting the A and B. When the electric current flows to the whole lamps, the secondary coils S1 and S2 or S3 and S4 of each output transformer becomes the identical potential by the operation of the shunt chalk shunt transformer) and also, as the A and B points are connected, the secondary coils S11, S2 and the secondary coils S3, S4 become the voltage in the neighborhood value. When the A and B points are connected and are connected to the ground through the high resistor line 234, the voltage corresponding to the electric current flowing in the ground through the high resistor 234 generates at the point C. Theoretically, the C point is at the zero volt, but the C point maintain the potential offset from the zero point by the unbalance between the secondary coils S11, S2 and the secondary coils S3, S4 due to the floating capacity of the output transformer or the leakage inductor and the like. It may be suggested to determine the value of the resistor 234 so that this potential becomes the safe voltage, but the potential of the C point fluctuates by the condition of the external temperature and the like so that in this embodiment, for the time being, it is set at 1 ohm. However, this resistance value is not a limiting value, and may be chosen from a proper value among values higher than the whole impedance.

Furthermore, in the execution of the embodiment of the present invention, it is not indispensable condition to ground the line 234 by means of the high resistor 234. When the unbalance between the secondary coils S1, S2 and the secondary coils S3, S4 becomes large, the unbalance electric current flowing through the high resistor 234 increases. This electric current becomes totally invalid electric current which becomes a cause of deterioration of efficiency, but in this embodiment, the unbalance condition generated between the secondary oils S1-S4 on account of the serial connection of the A and B points changes by the flow of the electric current corresponding to the unbalance between the coils which results in the amendment of the unbalance, changing the potential at the C point becomes zero, and the luminance of each lamp L1-L12 becomes a constant. Furthermore, the leakage of the capacitive charge at the core portions 222a and 222b or the reduction of the magnetic flux 230 crossing between the core portions 222a and 222b occurs. The other constructions of the present embodiment illustrated in FIT. 12 are identical with the embodiment illustrated in FIG. 11.

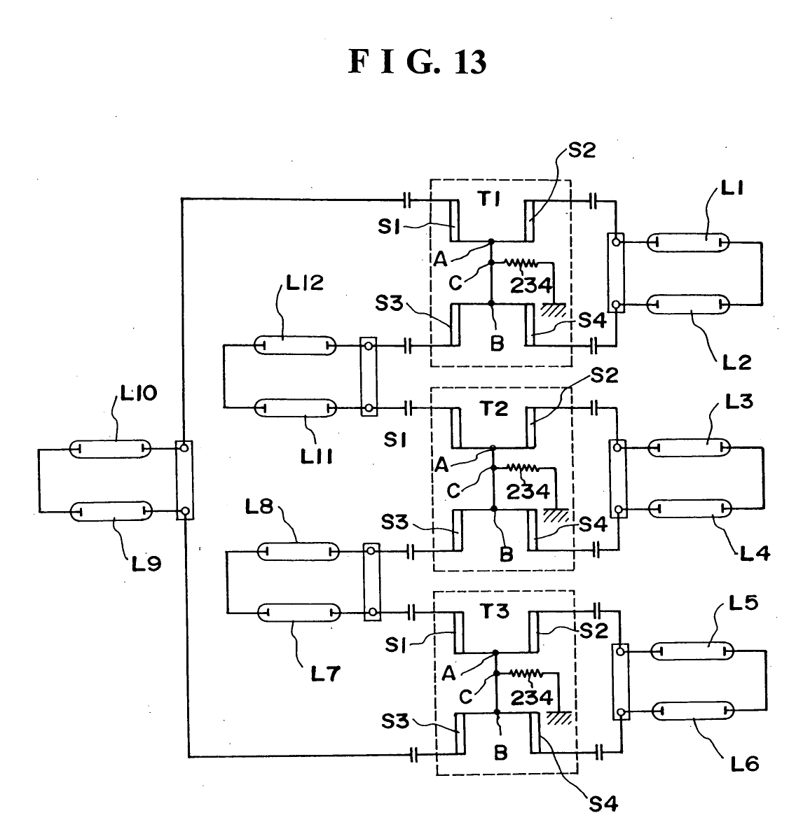

FIG. 13 shows an embodiment wherein each output terminal of the whole secondary coils S1-S4 in the total of 12 pieces at the secondary side of the output transformers T1, T2, T3 is connected in series mutually on the loop circuit forming the closed loop. One and the other of each pair of lamps are connected to output terminals of the secondary coils in counter phase relation respectively. The construction of a connecting circuit of short-circuiting the A and B points at the secondary side of each transformer is identical with the construction shown in FIG. 12, but may be regarded the same with the construction shown in FIG. 11.

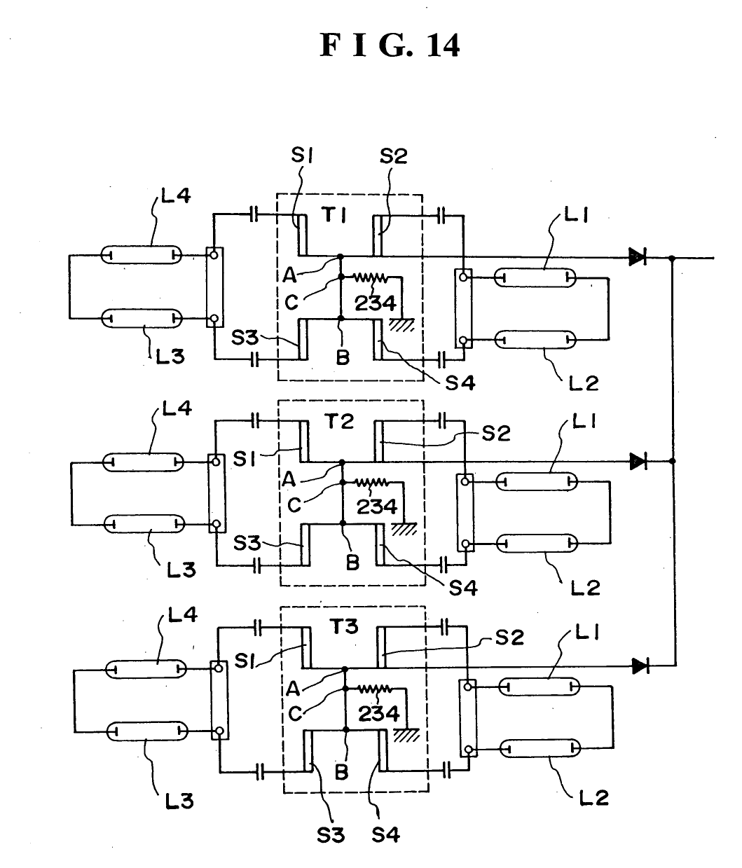

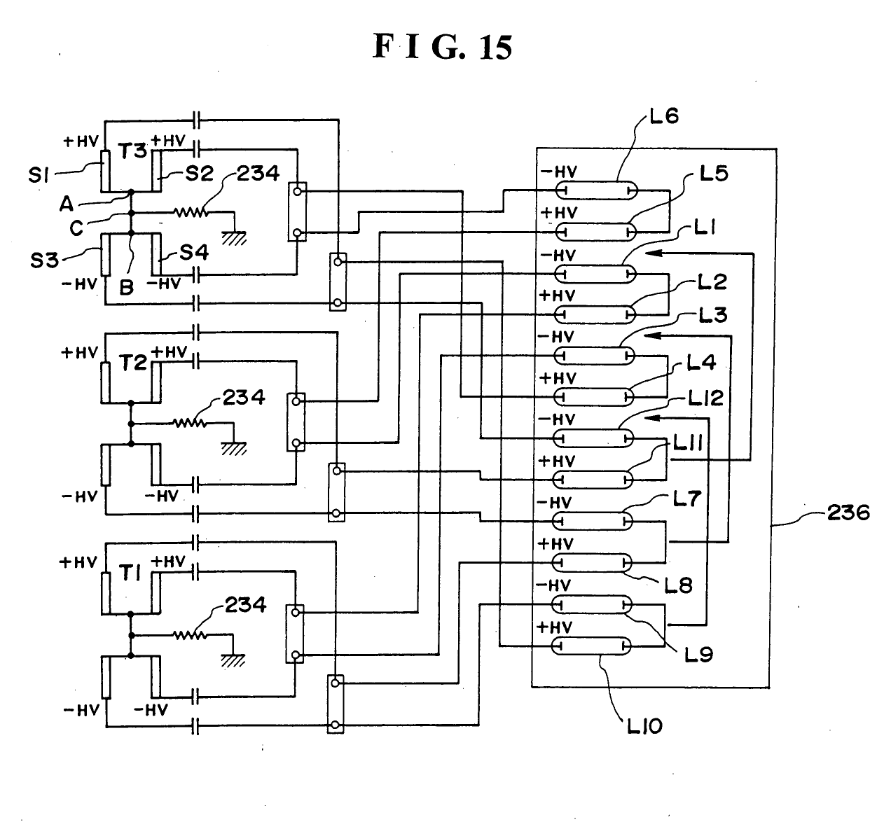

FIG. 14 shows a construction wherein a closed loop electric current carrying route is formed for each transformer T1-T3, and 4 pieces of lamps L1-L4 are F connected i series to each electric current carrying route. FIG. 15 shows an example of preferred arrangement of the lamps L1-L12 against a backlight unit substrate 236. Connecting terminals of left end of the lamp on the substrate 236 are arranged to be in counter phase mutually.

In the drawing, −HV and +Hv shows secondary high tension output mutually in counter phase. For example, when the output- HV is impressed to the connecting terminals a, c, e, f, i, k of each lamp arranged, for example in this order, the output +HV is impressed to the connecting terminals b, d, e, h, 1. As described above, a feasibility of obtaining a preferred drive characteristic is experimentally confirmed with the foregoing construction. When the construction is of mutually counter phase relation of the connecting terminals of left side of each lamp L1-K12, the present invention is not limited particulary to the arrangement of the lamps as shown in FIG. 15, and the position of the lamp may be changed to a position indicated by the arrow mark in the drawing, and other arrangements are connected with lead wires but this invention is not particularly limited to this construction, and one piece of U-shaped tube lamp may be used instead of a pair of lamps can be used. Furthermore, each output transformer used in this invention is identical and the number of windings of each secondary coil is identical.

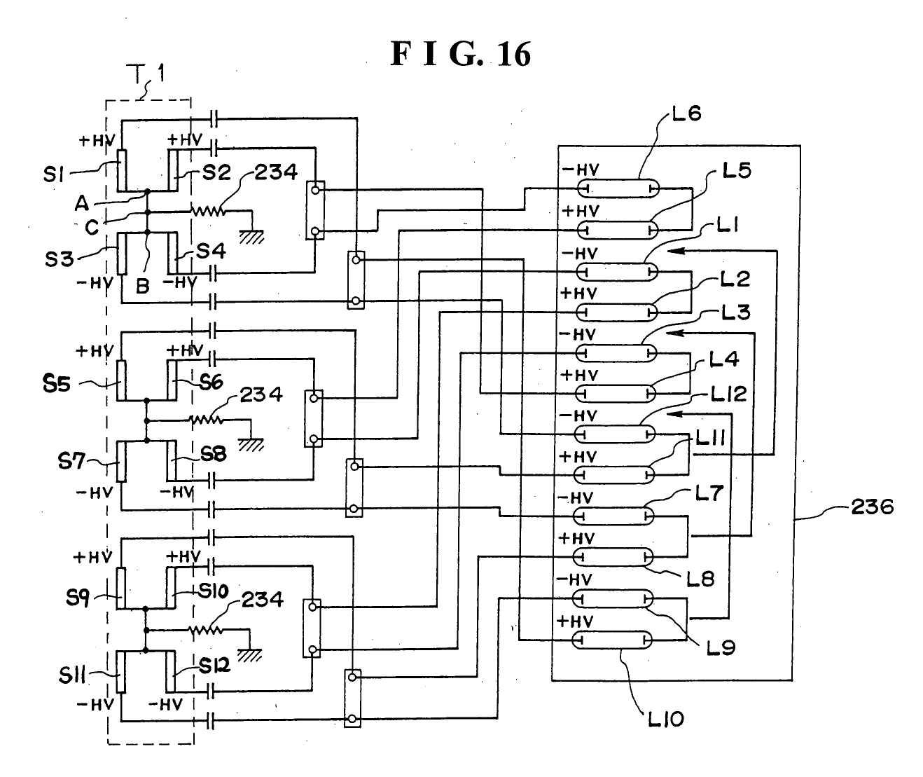

Furthermore, the present invention has made it possible to light up a large number of the lamps L1-L12 uniformly by using a single output transformer TF 1 of 1 output.12 outputs type formed by winding the secondary windings S1-S12 on the identical core as shown in FIG. 16. The embodiment shown in FIG. 15 is identical with the embodiment shown in FIGS. 15 and 13 except for the contruction using 1 output transformer instead of 3 pieces of the transformers T1, T2, and T3.

1. An illumination unit drive circuit wherein each primary side of a plurality of output transformers of 1 input-plural output type of mutually identical standard are connected mutually, and AC signals are inputted to the primary sides, and high tension output is induced at the secondary side of each output transformer, and a plurality of the illumination units are operated by the high tension output, an improved illumination unit drive circuit wherein among a plurality of the illumination units, one or a series of mutually connected electrodes of one side of the plural illumination units is connected to an output terminal at the secondary side of one part of the output transformer, and the other electrode or one piece or series of mutually connected electrodes of the other side of a plurality of the illumination units is connected to the high tension output terminal at the secondary side among the pair of the output transformers which are of counter phase from the high tension output terminal at the secondary side of the one output transformer.

2. An illumination unit drive circuit according to claim 1 wherein the output transformer is 1 input-2 output type winding transformer, and the illumination unit is of a cold cathode fluorescent lamp.

3. An illumination unit drive circuit according to claim 1 wherein the plural output transformers are of two pieces of the 1 input-2 output type wound type transformer, and one or a serially connected plural illumination units are connected between the secondary side high tension terminal of the wound type transformer among the 2 pieces of wound type transformers and the secondary side high tension terminal of the other wound type transformer of counter phase with the high tension terminal.

4. An illumination unit drive circuit according to claim 1 wherein the plural output transformers are two pieces of 1 input-plural output type transformers, and the illumination unit is connected between one secondary side high tension terminal of one output transformer among the two pieces of the output transformers and one secondary side high tension terminal of the other transformers, and illumination units are connected between two pieces of the high tension terminals at secondary sides of each output transformer which are of mutually counter phase, and each illumination unit is connected between remaining one piece of the secondary side high tension terminal of each output transformer and the secondary side ground terminal.

5. An illumination unit drive circuit according to claim 1 wherein the plural output transformers are two pieces of 1 input-multiple output type output transformers, and an illumination unit is connected between each secondary side high tension terminals i, j, k, l of one output transformer among the two pieces of the output transformers and each secondary side high tension terminal p, 0, n, m of other output transformer among the two output transformers which are in counter phase with the secondary side high tension terminals i, j, k, l, and the secondary side low tension terminals a, b, c, d, e, f, g, h of the two pieces of the output transformers are respectively earthed.

6. An illumination unit drive circuit according to claim 1 wherein the plural output transformers are at least three pieces of 1 input-multiple output type wound transformers, and the secondary side high tension terminal of one wound type transformer among at least the three pieces of the wound transformer and the secondary side high tension terminal of counter phase of the secondary side high tension terminal of the one wound type transformer among other wound type transformers are connected by means of one or serially connected plural illumination units, and all the secondary high tension terminals of the wound type transformers are connected in loop form.

7. An illumination unit drive circuit according to claim 1 wherein the secondary wirings are formed with a plurality of wires arranged in parallel forms.

8. An illumination unit drive circuit according to claim 1 wherein the output transformers are of wound type transformers mounted with the primary winding and the secondary winding on the bobbin inserted with the core, an improvement wherein the first secondary winding is wound on the bobbin, and the second secondary winding of identical number of winding with the first secondary winding wound on the secondary winding by means of the insulator, and a plurality of the secondary windings are laminated on the bobbin which are mutually identical number of winding.

9. An illumination unit drive circuit wherein primary sides of a plurality of output transformers of 1 input-plural output type are connected, and the respective illumination units are connected to the secondary side of each output transformer, and a plurality of illumination units are lighted up by the high tension output induced at the secondary side of each output transformer, an improved illumination unit drive circuit wherein a loop circuit is formed by connecting the output terminals in series in closed loop type to connect all the secondary output terminals of each of the output transformer to the secondary output terminals of counter phase type in mutual counter phase, and an illumination unit is connected between a secondary output terminal of the output transformer and the output terminal of the other output transformer in counter phase with the output terminal.

10. An illumination unit drive circuit according to claim 9 wherein a circuit for detecting abnormal voltage is connected to a connecting point of the secondary output terminal and the secondary output terminal in counter phase with the other secondary output terminal.

11. An illumination unit drive circuit according to claim 9 wherein a voltage clamp circuit is connected to a connecting point of the secondary output terminal and the secondary output terminal of counter phase.

12. An illumination unit drive circuit according to claim 9 wherein one side of a plurality of each coil at secondary side of a plurality of output transformers are mutually short-circuited.

13. An illumination unit drive circuit according to claim 12 wherein a wire for short-circuiting one side of each coil at the secondary side mutually is earthed by means of a high resistor element.

14. An illumination unit drive circuit according to claim 9 wherein each of a plurality of output transformers has four pieces of secondary coils on an identical core, and one side of the four pieces of the secondary coils are all short-circuited, and the short-circuiting line is earthed by means of a high resistor element.

15. An illumination unit drive circuit according to claim 1 wherein a plurality of illumination units are arranged in parallel mutually on the substrate, and mutually adjacent one terminal of each illumination unit becomes in counter phase.

16. An illumination unit drive circuit wherein primary sides of a plurality of output transformers of 1 input-multiple output type are respectively connected, and illumination units are respectively connected to the secondary side of each output transformer, and a plurality of the illumination units are lighted up by the high tension output induced at the secondary side of each output transformer, an improved illumination unit drive circuit wherein the secondary output terminals of each output transformer are connected in series in closed loop form to provide a loop circuit so that the secondary output terminals of mutually in counter phase are connected, and a plurality of illumination units are connected to the loop circuit so that the voltage of counter phase is impressed to the electrodes of both the terminals of the illumination units.

17. An illumination unit drive circuit wherein a plurality of illumination units are connected to secondary side of the single output transformer of 1 input-plural output type, and a plurality of the illumination units are lighted up by the high tension output induced at the secondary side of the output transformer, an improved illumination unit drive circuit wherein all or a plurality of secondary outputs of the output transformers are connected in series in closed loop form to form a loop circuit so that the secondary output terminals of mutually in counter phase are connected, and a plurality of the illumination units are connected to the loop circuit so that the voltage of counter phase is impressed to the electrodes of both terminals of the illumination units.

18. An illumination unit drive circuit according to claim 17 wherein a plurality of illumination units are disposed on substrate to be in parallel and side by side mutually, and terminals of adjacent end of each illumination unit becomes in counter phase.

19. An illumination unit drive circuit according to claim 9 wherein a plurality of illumination units are arranged in parallel mutually on the substrate, and mutually adjacent one terminal of each illumination unit becomes in counter phase.
